(19) United States
(12) Patent Application Publication
(10) Pub. No.: US 2016/0245265 A1
(43) Pub. Date: Aug. 25, 2016

(54) Enclosed Solar Chimney Power Plan

(71) Applicant: Christos PAPAGEORGIOU, kifisia Attikis (GR)

(72) Inventor: Christos PAPAGEORGIOU, kifisia Attikis (GR)

(21) Appl. No.: 15/027,807

(22) PCT Filed: Oct. 6, 2014
(86) PCT No.: PCT/GR2014/000059

§ 371 Date: Apr. 7, 2016

(30) Foreign Application Priority Data
Oct. 8, 2013 (GR) 20130100574

(51) Int. Cl. F03G 6/04

(52) U.S. Cl. CPC F03G 6/045

(57) ABSTRACT

An enclosed solar chimney power plant is formed by the way of its solar collector (greenhouse) construction. The enclosed solar collector (greenhouse) has a transparent roof and it is surrounded by a peripheral vertical wall. On this peripheral vertical wall there are circular openings through which the incoming air stream is entering, replacing the warm air that is escaping continuously through the solar chimney. The incoming air stream in each opening is forcing to rotate its corresponding air turbine and its engaged electric generator generating electricity. In each opening there is an electromechanical air blocking system which can release or block the entering air stream and may also connect or disconnect the electric generator to the grid.

Conventional solar chimney power plants (Solar Updraft Power Plants) usually are made of the following parts:
A circular solar collector, which is a circular greenhouse with a transparent roof, open to its periphery. The solar irradiation is passing though the greenhouse's transparent roof, and is heating the ground beneath it. Thus the air inside the greenhouse is also heated and becomes warmer than the ambient air. Its transparent roof is preventing thermal radiation from escaping towards the sky and is eliminating heat transfer to its surrounding.
A cylindrical solar chimney placed in the center of the circular solar collector through which the warm air is escaping to the upper atmosphere. The escaping warm air is continuously replaced by fresh air entering through the open periphery of the greenhouse.
One or more air turbines placed inside the solar chimney (of vertical axis) or around the base of the solar chimney (of a horizontal axis), which are forced to rotate by the moving stream of warm air, escaping through the solar chimney.
The air turbines are engaged (via appropriate gear boxes) to electrical generators, generating electricity.

Extensive description and important information about solar chimney technology are posted on the website http://en.wikipedia.org/wiki/Solar_updraft_tower

Thus the solar chimney power plants operate with the moving air stream due to the escaping warm air through the solar chimney. The moving air stream is warmed by the solar irradiation passing through the transparent roof of the greenhouse.

The warmed air mass inside the greenhouse becomes less dense than the ambient air thus its buoyancy is pushing the air inside the greenhouse to escape through the solar chimney to the upper layers of the atmosphere.

The escaping air mass through the solar chimney is replaced by fresh air entering the open surface of the greenhouse. The entering ambient air is heating during its motion from the periphery of the greenhouse towards the base of the solar chimney and forced to escape through it etc.

Thus the solar chimney power plants are practically creating artificial wind, passing through its open periphery and forcing the air turbines and their engaged electric generators to rotate, generating electricity.

Note that due to the thermal storage capacity of the soil beneath the solar collector, solar chimney power plants can generate uninterrupted electricity, 365 days a year 24 hours a day if necessary.

Generally we can prove that at a particular location of a solar chimney power plant, the annual electricity (and its rated electric power) is proportional to the product of the height of the chimney on the area of the solar collector. I called the coefficient ratio geometric performance of the plant, and as it is evident from the small experimental power plant built at Kompotades GREECE, http://www.youtube.com/watch?v=RVJIM6spTjU, the geometric performance of solar chimney power plants can be improved significantly with the change in dimensions and geometrical arrangement of the principal components of the plant.

Conventional solar chimney power plants have the following disadvantages, which could be overcome by the—proposed in the present invention—enclosed solar chimney power plant, as described hereafter:
Conventional solar chimney power plants require large area greenhouses and huge chimneys resulting to increased construction costs per generated KWh and this is a serious disadvantage that eliminated the application of solar chimney technology. The correction of this drawback can be made, as proposed in the present invention, by increasing the geometric efficiency of solar chimney power plants, which can be achieved by changing the position of the turbines (i.e. removing them from the base of the solar chimney and placing them in suitable openings in the enclosing wall surface of the solar collector) and proper choice of their diameters, in relation to the diameter of the solar chimney.
The main reason for the reduced geometric efficiency of conventional solar chimney power plants, is that their turbines are mounted either within or adjacent to the solar chimney where the ascending air speed is low (equal to or similar to the speed of the air stream in the chimney). Therefore the turbines convert a proportion of the kinetic energy of the rising column of air through the solar chimney into electricity. Note, however, that the kinetic energy of the rising column into the solar chimney is too small compared to the thermal power generated by the solar collector.

The rate of conversion of kinetic energy into electricity is equal to the product of the efficiencies of the air turbine and its electric generator.
The air turbines of the enclosed solar chimney power plants are placed on circular openings on the enclosing peripheral wall of their solar collector. Choosing the diameters of the air turbines so that their overall sum cross section be several times smaller than the cross section of the solar chimney, the speed of the air stream passing through the air turbines can be quite higher in comparison to the air speed inside the solar chimney.

Therefore the kinetic energy of the air passing through the air turbines and of which a percentage will be converted into electricity, is significantly greater than the kinetic energy of the rising column of the solar chimney. Experimentally this it was shown in a small enclosed solar chimney power plant built at Kompotades Greece.
Thus increasing the geometric performance, with the proposed enclosed solar chimney power plants we can build enclosed solar chimney power plants with smaller solar chimneys and smaller area greenhouses than their equivalent conventional solar chimney power plants.
Another disadvantage of conventional solar chimney power plants is the use of mechanical gear boxes placed between their air turbines and their electric generators. These gear boxes are machines with high costs and require careful and frequent maintenance. These are necessary in conventional solar chimney power plants since the speed of the air stream of their air turbine is relatively small and therefore the frequency of rotation of its air turbines is small in comparison to the rotational frequency of the generators, which is determined by the frequency of the grid and their number of poles. Therefore it is necessary to place appropriate gearboxes between them.

The air turbines in the enclosed solar chimney power plants can always operate at higher air speeds and therefore do not need gearboxes. The fine adjustment of the frequency of rotation and the consequent optimization of their performance can be achieved, if necessary, using electronic frequency converters.
In addition, the conventional solar chimney power plants in the periods when solar irradiation is small and are operating with low air speeds and therefore the generators run on a small fraction of its rating power, their efficiencies are very low. Furthermore the electronic frequency converters accompanying their electric generators cannot adjust well the frequency of rotation of the turbines at very low speed of the incoming air stream and their air turbines also will have very low efficiencies. This effect limits the efficiency of the electrical generation system in low irradiation periods and therefore is reducing the annual electricity generation of the conventional solar chimney power plants.
Instead, the enclosed solar chimney power plants, as we shall see, have a significant number of turbines and a part of them can be closed during periods of low irradiation and low incoming air speeds, so that the operating air turbines receive increased air speed streams which permits them to operate with increased power and eliminating the previous drawbacks of conventional solar chimney power plants.
A further disadvantage of conventional solar chimney power plants is that their air turbines are machines operating at low speed and have large diameters (almost like the wind turbines) thus they require special design and construction and therefore are not available in the market.

By increasing the air speed of the air turbines and deceasing their diameters, and therefore increasing their speed of rotation as it is proposed for the enclosed solar chimney power plants , we can use appropriate axial fans, already existing in abundance in the market, as air turbines.

So the proposed invention, based on the new elements that emerged from the recent study of the small experimental solar chimney power plant built in Kompotades Greece http://www.youtube.com/watch?v=RVJIM6spTjU, is a much simpler and lower cost solar chimney power plant, named enclosed because its solar collector is closed peripherally and eliminates all the disadvantages of the conventional solar chimney power plant technology.

Moreover the proposed enclosed solar chimney power plant has other important advantages, such as the fact that it needs little maintenance and can be combined with solar PV panels or solar parabolic troughs to build hybrid solar power plants.

The basic elements of a typical enclosed solar chimney power plant, needing detailed description, that differs from the corresponding elements of a conventional solar chimney power plant, are:
The enclosed solar collector (enclosed greenhouse)
The electricity generation system, which is a set of axial fans, operating in reverse as air turbines, rotating their engaged electrical generators which are connected directly to them, i.e. without intermediate mechanical gearboxes.
The mechanical adjustment system blocking the entering air streams, which rotate the air turbines and their engaged electric generator in order to optimize the
performance of the open air turbines and the system as a whole.
Finally, we describe how the proposed enclosed solar chimneys power plants can be combined with solar PV panels in order to operate as hybrid solar power plants using the same surface area of the enclosed solar collector.
Indicatively the enclosed solar collector (enclosed greenhouse) of the invention may be a truncated pyramid made of a polygonal wall (1.1) where its glass roof (1.2) is based on an appropriate steel infrastructure mounted on the ground.

The glass roof on the top of the truncated pyramid is embracing tightly the solar chimney to ensure the tightness of the solar chimney. The glass roof of this truncated pyramid is elevated towards the solar chimney in order to facilitate the movement of the inner air stream, while dust that normally is resting on the outer glass surface (1.3) can be removed by outside winds, rain or by any artificially cleaning procedure.

The glass roof of the greenhouse is resting firmly on the vertical peripheral wall (1.1) that encloses the solar collector.

The air turbines are placed inside appropriate circular openings (1.4) on the vertical peripheral wall which is enclosing the solar collector. The height of the outer vertical wall enclosing the solar collector is therefore greater than the diameter of the air turbines. The peripheral wall that is enclosing the solar collector may be of transparent or opaque material while the air turbines (2.1) are always of horizontal axis and fitted with an appropriate inclination to the radius of the peripheral wall in order for the stream of cold air entering through the turbines to form a whirl.

Each opening of an air turbine will be equipped with a moving air blocking system (2.3). Each air blocking system, remotely controlled, can open or close tightly its respective opening releasing or blocking the flow of air that is forcing to rotate its respective air turbine, while simultaneously are connecting and disconnecting the electric power to its corresponding generator (2.2). So when the speed of the incoming air stream to the air turbine is less of a set point will block the flow of certain openings, so the air flow to the remaining openings will be fortified.

Also in each opening (1.4), and on top of the solar chimney, there can be installed a metal mesh blocking the entry of any small animal or bird into the greenhouse. In the enclosing peripheral wall there should exist at least one access door to the inner part of the solar collector (greenhouse).

The soil beneath the roof of the solar collector can be covered with a rubber or plastic black cover to ensure greater absorption of solar irradiation passing through the transparent glass roof of the solar collector.

Below or on the black soil cover, if necessary, there can be placed closed pipes filled with water in order to increase the thermal capacity of the soil to ensure the operation of the power plant well beyond the sunset.

From the description of the solar collector it is obvious that its base, which can be covered by the black soil cover, is free, except at the points where the metal supports of the infrastructure of the glass roof are mounted. Thus this empty surface can be used as a placement land for photovoltaic (PV) panels or solar parabolic troughs. PV panels, if possible, can be installed even without their protective glass cover, as they are protected beneath the glass roof of the enclosed solar collector.

The PV panels, using simple and low cost brackets can be installed inside the enclosed solar collector and take the tilt and orientation required. Also note that if required for better performance, the PV panels may be moved seasonally, by qualified personnel, changing their inclination or orientation.

Because photovoltaic panels and parabolic trough mirrors are protected without the adverse influence of external weather phenomena (rain, snow, hail, humidity, strong winds, lightning, etc.) are likely to have better performance and will definitely have a longer life.

The presence of PV panels or parabolic troughs beneath the glass roof of the enclosed solar collector does not substantially affect the electricity generation output of their enclosed solar chimney power plants.

Based on this a hybrid solar power plant that combines an enclosed solar chimney power plant and a photovoltaic park with PV panels installed on the floor of the enclosed greenhouse will have the following advantages:
The hybrid solar power plant will have a lower construction cost than the sum of cost of its units, if they were made as independent power plants
The hybrid solar station uses less land area than the corresponding photovoltaic park of the same nominal power, and can produce more electricity per year and requires less maintenance.

The hybrid solar station can operate several hours after sunset and if necessary continuously throughout the course of 24 hours, due to its enclosed solar chimney power plant

Similar analysis with similar positive results will result from hybrid solar power plants consisting of an enclosed solar chimney power plant combined with parabolic troughs placed inside the enclosed greenhouse under its glass roof.

So the enclosed solar chimney power plant, beyond its advantages, compared to the conventional solar chimney power plant, has also the useful property to be combined with the major solar technologies creating hybrid solar power plants with lower construction cost, lower maintenance cost and other important advantages compared with the conventional solar power plants.

### DESCRIPTION OF FIGURES

FIG. 1. Indicative figure of an enclosed solar chimney power plant

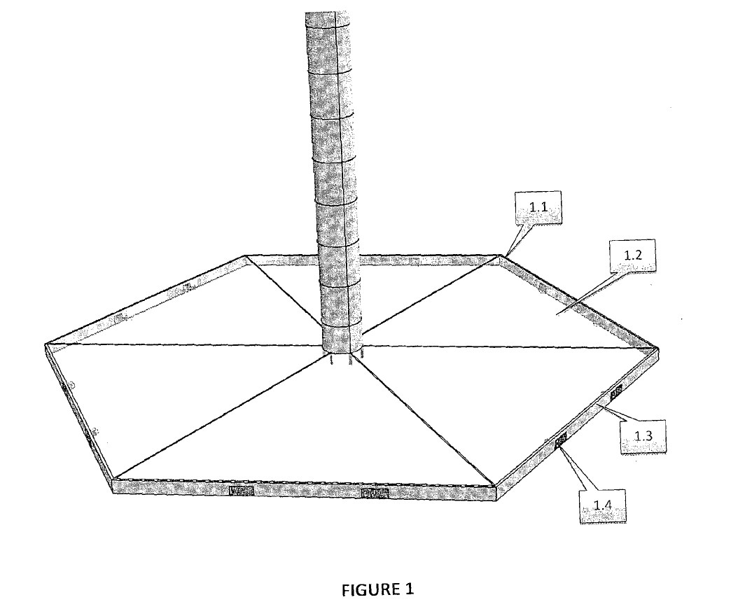

1.1 Enclosed solar collector (enclosed greenhouse)

1.2 Transparent glass roof of the enclosed solar collector

1.3 Peripheral wall of the enclosed solar collector

1.4 Indicative opening of the peripheral wall

FIG. 2. Indicative figure of an opening on the peripheral wall with its air turbine, electric generator and its air blocking system

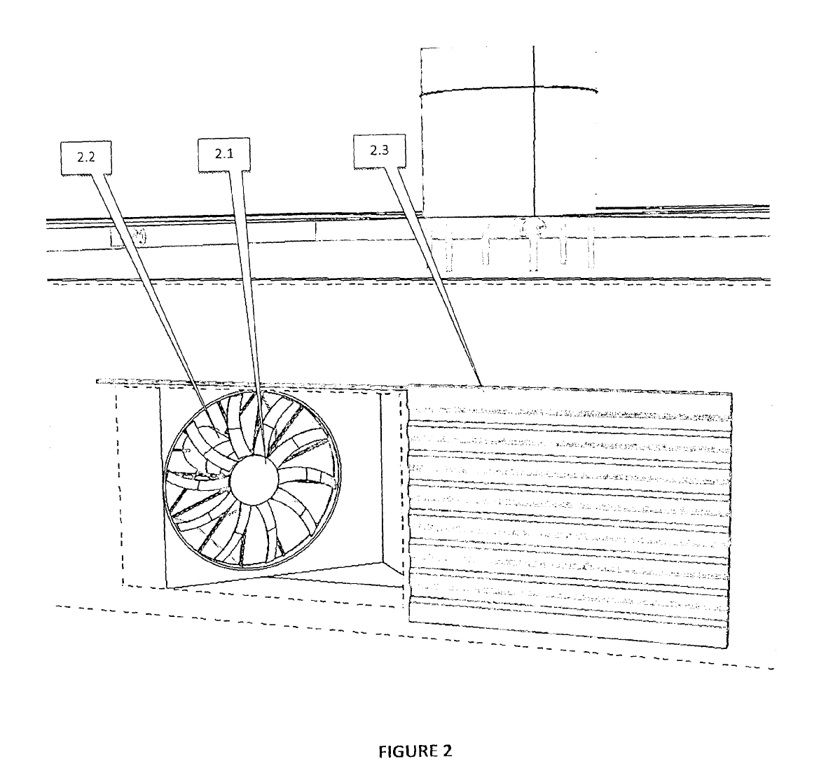

2.1 Air turbine

2.2 Electric generator

2.3 Indicative air blocking system

1. Enclosed solar chimney power plant characterized by including an enclosed solar collector (1.1), i.e. a greenhouse with a transparent roof (1.2) surrounded by a peripheral vertical wall (1.3) and which carries a plurality of circular openings (1.4) inside which are mounted the electricity generating power units, each of which consists of an air turbine (2.1) connected directly to its corresponding electric generator (2.2) and an electromechanical air blocking system (2.3) which can release or block the incoming air stream to its corresponding opening and can also connect or disconnect the corresponding generator located in the openings.
